(19) United States
(12) Patent Application Publication
(10) Pub. No.: US 2025/0154747 A1
(43) Pub. Date: May 15, 2025

(54) LIGHT GUIDE DEVICE AND LIGHT GUIDE METHOD

(71) Applicant: HD Hyundai XiteSolution Co., Ltd., Seongnam-si (KR)

(72) Inventors: Sang Min AN, Seongnam-si (KR); A Reum SEO, Seongnam-si (KR); Eun Sook SEO, Seongnam-si (KR); Soo Yeon SEOK, Seongnam-si (KR); Hee Jun JEONG, Seongnam-si (KR)

(21) Appl. No.: 18/948,689

(22) Filed: Nov. 15, 2024

(30) Foreign Application Priority Data
Nov. 15, 2023 (KR) 10-2023-0158378

(51) Int. Cl. E02F 9/26

(52) U.S. Cl. CPC E02F 9/264

(57) ABSTRACT

According to an embodiment of the present invention, a light guide device may determine the type of attachment attached to an excavator, determine a position of the attachment attached to the excavator based on an angle of each of joint parts of the excavator acquired by an angle sensor, determine a shape of a projected object based on the determined type of the attachment, generate a control signal for projecting the projected object onto a projection position on an operation surface corresponding to the position of the attachment, transmit the control signal to a projection module, and the projection module may implement the projected object at the projection position on the operation surface based on the received control signal.

### CROSS REFERENCE TO RELATED APPLICATION

The present application claims priority to Korean Patent Application No. 10-2023-0158378, filed on Nov. 15, 2023, the entire contents of which are incorporated herein for all purposes by this reference.

### TECHNICAL FIELD

The following embodiments relate to a light guide device and a light guide method.

### BACKGROUND

In general, various excavators 200, such as backhoes, dozers, payloaders, and dump trucks, are utilized in earthmoving operations in construction projects. Among various construction machines, the excavator performs important functions of digging, leveling, loading, and unloading.

Specifically, the excavator, at civil engineering, building, and construction sites, performs various operations in addition to basic operations such as an excavation operation of digging land, a loading operation of transporting soil to a dump truck, a crushing operation of dismantling buildings and stone, a leveling operation of leveling a ground surface, an operation of lifting and suspending a heavy object, and an operation of picking up an object by using pincers.

When an operator of the excavator intends to align a position of an attachment with a position at which an operation is intended to be performed, there may occur a difference between the positions depending on the operator's skill.

In addition, it is necessary for surrounding operators to recognize the position of the attachment included in the construction machine in order to ensure safety.

However, because there is no means for indicating a relative position of the attachment based on an operation position at which the operation is to be performed, a large amount of time is required to align the position of the attachment with the position at which the operation is intended to be performed, and efficiency of the operation may deteriorate. This problem may be more severe in case that the excavator is operated remotely.

### SUMMARY

The present disclosure is proposed to solve these problems and aims to provide a light guide device and a light guide method that may project a position of an attachment included in a construction machine onto a terrain on which the construction machine is positioned.

According to an embodiment of the present disclosure, a light guide system may include an angle sensor disposed for each of joint parts of an excavator and configured to acquire an angle of each of the joint parts of the excavator, a projection module configured to implement a projected object by using light, and a light guide device operatively connected to the angle sensor and the projection module.

The light guide device may determine a position of an attachment attached to the excavator based on the angle of each of the joint parts of the excavator acquired by the angle sensor, determine an operation surface based on workplace drawing information or operation information, and generate a control signal for projecting the projected object onto a projection position on the operation surface corresponding to a position of the attachment and transmit the control signal to the projection module, and the projection module may implement the projected object onto the projection position on the operation surface based on the received control signal.

The light guide device may determine the type of the attachment attached to the excavator and determine a shape of the projected object based on the determined type of the attachment.

The light guide device may determine the projection position as a position at which the attachment is vertically projected onto the operation surface, and the shape of the projected object may be a shape when the attachment is vertically projected onto the operation surface.

The light guide device may include information on the projection position and the shape of the projected object in the control signal and transmit the control signal to the projection module, and the projection module may implement the projected object at the projection position by using light with a first wavelength preset therein.

The light guide device may determine a second wavelength of light for implementing the projected object, include information on the second wavelength, the projection position, and the shape of the projected object in the control signal and transmit the control signal to the projection module, and the projection module may implement the projected object at the projection position by using the light with the second wavelength.

The light guide device may determine an operation position at which the attachment is to operate based on the workplace drawing information or the operation information, include information on the operation position, the projection position, and the shape of the projected object in the control signal and transmit the control signal to the projection module, and the projection module may implement the projected object at the projection position by using light with a preset first wavelength and implements the projected object at the operation position by using light with a preset third wavelength.

The light guide system may further include an image capturing module configured to acquire image data of a periphery of the excavator, in which the light guide device displays image data acquired by the image capturing module on a preset screen. Further, the preset screen may include at least one of a screen provided in an operator seat of the excavator and a screen provided to an operator who remotely operates the excavator.

The image data may include the implemented projected object.

According to another embodiment of the present disclosure, a light guide system may include an angle sensor disposed for each of joint parts of an excavator and configured to acquire an angle of each of the joint parts of the excavator, a projection module configured to implement a projected object by using light and a light guide device operatively connected to the angle sensor and the projection module.

The light guide device may determine a position of an attachment attached to the excavator based on the angle of each of the joint parts of the excavator acquired by the angle sensor, determine the projection position as a position at which the attachment is vertically projected onto a ground surface, determine a shape of the projected object as a shape when the attachment is vertically projected onto the ground surface, generate a control signal for projecting the projected object onto the projection position and transmit the control signal to the projection module, and the projection module may implement the projected object at the projection position on the ground surface based on the received control signal.

According to still another embodiment of the present disclosure, a method of providing a light guide to an excavator by a light guide system may include determining the type of attachment attached to the excavator, acquiring an angle of each of joint parts of the excavator, determining a position of the attachment attached to the excavator based on the angle of each of the joint parts of the excavator, determining a shape of a projected object based on the determined type of the attachment and implementing the projected object at a projection position on an operation surface corresponding to the position of the attachment.

According to yet another embodiment of the present disclosure, an excavator may include an angle sensor disposed for each of joint parts of the excavator and configured to acquire an angle of each of the joint parts of the excavator, a projection module configured to implement a projected object by using light and a processor operatively connected to the angle sensor and the projection module, in which the processor may determine a position of an attachment attached to the excavator based on the angle of each of the joint parts of the excavator acquired by the angle sensor, determine an operation surface based on workplace drawing information or operation information, generate a control signal for projecting the projected object onto a projection position on the operation surface corresponding to a position of the attachment and transmit the control signal to the projection module, and in which the projection module implements the projected object onto the projection position on the operation surface based on the received control signal.

### BRIEF DESCRIPTION OF THE DRAWINGS

FIG. 1 is a view illustrating an autonomous operation system 100 according to various embodiments of the present invention.

FIG. 2 is a view for explaining an excavator according to various embodiments of the present invention.

FIG. 3 is a view conceptually illustrating an excavator 300 according to various embodiments of the present invention.

FIG. 4 is a view illustrating constituent elements that may be added to the excavator to implement a light guide system according to various embodiments of the present invention.

FIG. 5 is a view illustrating a configuration of a light guide device according to various embodiments of the present invention.

FIG. 6 is a flowchart illustrating a light guide method according to the embodiment of the present invention.

FIG. 7 is a flowchart illustrating a light guide method according to another embodiment.

FIG. 8 is a flowchart illustrating a light guide method according to still another embodiment.

FIG. 9 is a view illustrating a state in which the light guide device according to the embodiment of the present invention projects light onto a vertically lower side of an attachment in a shape corresponding to a shape of the attachment.

FIGS. 10A and 10B are views illustrating a state in which image data, which are related to a periphery of the excavator including the state in which the light guide device according to the embodiment projects light onto the vertically lower side of the attachment in the shape corresponding to the shape of the attachment, are displayed on a screen of an operator positioned remotely.

FIG. 11 is a view illustrating a state in which light is projected in a shape corresponding to the shape of the attachment onto the vertically lower side of the attachment included in the excavator and an operation position at which the attachment is to perform the operation.

FIG. 12 is a view illustrating a state in which light is projected in a shape corresponding to a shape of an attachment onto an operation surface on which the attachment attached to the excavator is to perform an operation according to another embodiment.

FIG. 13 is a view illustrating a state in which a shape corresponding to a shape of an attachment is transformed and projected depending on the attachment attached to the excavator according to the embodiment.

### DETAILED DESCRIPTION

Specific structural or functional descriptions of the embodiments according to the concept of the present invention disclosed in the present specification are exemplified only for the purpose of explaining the embodiments according to the concept of the present invention, the embodiments according to the concept of the present invention may be carried out in various forms, and the present invention is not limited to the embodiments described in the present specification.

Because the embodiments according to the concept of the present invention may be variously changed and may have various forms, the embodiments will be illustrated in the drawings and described in detail in the present specification. However, the descriptions of the embodiments are not intended to limit the embodiments according to the concept of the present invention to the specific embodiments, and the present invention covers all modifications, equivalents, and alternatives falling within the spirit and technical scope of the present invention.

The terms such as “first,” “second,” and other numerical terms may be used herein only to describe various elements, but these elements should not be limited by these terms. These terms are used only for the purpose of distinguishing one constituent element from other constituent elements. For example, without departing from the scope according to the concept of the present invention, the first constituent element may be referred to as the second constituent element, and similarly, the second constituent element may also be referred to as the first constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements. Other expressions, that is, “between” and “just between” or “adjacent to” and “directly adjacent to”, for explaining a relationship between constituent elements, should be interpreted in a similar manner.

The terms used in the present specification are used to just describe a specific embodiment and do not intend to limit the present invention. Singular expressions include plural expressions unless clearly described as different meanings in the context.

In the present specification, it should be understood the terms “comprises,” “comprising,” “includes,” “including,” “containing,” “has,” “having” or other variations thereof specify the presence of stated features, numbers, steps, operations, elements, components, or combinations thereof, but do not preclude the presence or addition of one or more other features, numbers, steps, operations, elements, components, or combinations thereof.

Unless otherwise defined, all terms used herein, including technical or scientific terms, have the same meaning as commonly understood by those skilled in the art to which the present invention pertains.

The terms such as those defined in a commonly used dictionary should be interpreted as having meanings consistent with meanings in the context of related technologies and should not be interpreted as ideal or excessively formal meanings unless explicitly defined in the present specification.

In the following description, identical reference numerals refer to identical components, and unnecessary redundant descriptions and descriptions of publicly-known technologies will be omitted.

In the embodiment of the present invention, the terms ‘communication,’ ‘communication network,’ and ‘network’ may be used as in the same meaning. These three terms refer to wired and wireless local-area and wide-area data transmission and reception networks that may transmit or receive files to or from a user terminal, another user terminals, and a download server.

Hereinafter, the present invention will be described in detail through description of preferred embodiments of the present invention with reference to the accompanying drawings.

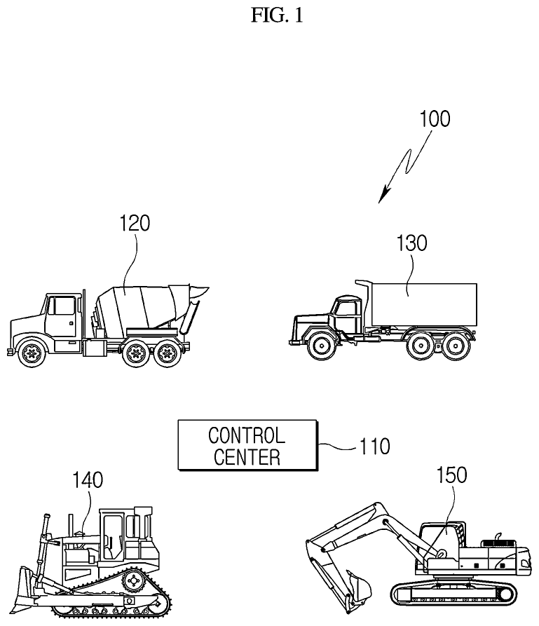

FIG. 1 is a view illustrating an autonomous operation system 100 according to various embodiments of the present invention.

With reference to FIG. 1, the autonomous operation system 100 according to various embodiments may include a control center 110, and one or more construction machines (or autonomous operation construction machines) 120, 130, 140, and 150.

According to various embodiments, the construction machines 120, 130, 140, and 150 refer to machines that perform operations at civil engineering and construction sites. As illustrated in FIG. 1, the construction machines 120, 130, 140, and 150 may include a mixer truck 120, a dump truck 130, a dozer 140, and an excavator 150.

However, this is provided for illustrative purposes only. The construction machines may include various machines such as a crane, a wheel loader, and a scraper.

According to the embodiment, the construction machines 120, 130, 140, and 150 may perform operations by the operator in response to operation instructions received from the control center 110. According to another embodiment, the construction machines 120, 130, 140, and 150 may autonomously operate without the operator. The operation instruction may include information on an operation region in which the corresponding construction machine needs to perform the operation, and information on an operation that needs to be performed in the operation region. For example, the construction machines 120, 130, 140, and 150 may move to the operation regions and perform the operations in response to the operation instructions without the user's manipulation or based on the user's manipulation.

The construction machines 120, 130, 140, and 150 may be equipped with various sensors. A state of the construction machine and/or a surrounding environment of the construction machine may be detected based on information acquired by the sensor, and the detection result may be taken into account when the operation is performed.

In addition, the construction machines 120, 130, 140, and 150 may be equipped with instrument panels configured to display information on the construction machines 120, 130, 140, and 150 or perform control setting on the construction machines 120, 130, 140, and 150. According to the embodiment, the instrument panel may have a touch sensor capable of receiving the user's touch input, and the touch sensor may acquire information on which image in the instrument panel is touched and executed by the user. The construction machines 120, 130, 140, and 150 may collect information on the user's touch on the instrument panel and transfer the information to the control center 110.

According to various embodiments, the control center 110 may refer to a system configured to manage at least one of the construction machines 120, 130, 140, and 150 employed at workplaces. According to the embodiment, the control center 110 may instruct at least one of the construction machines 120, 130, 140, and 150 to perform the operation. For example, the control center 110 may generate operation instructions that define the operation region and the operation that needs to be performed in the corresponding operation region, and the control center 110 may transmit the instructions to at least one of the construction machines 120, 130, 140, and 150.

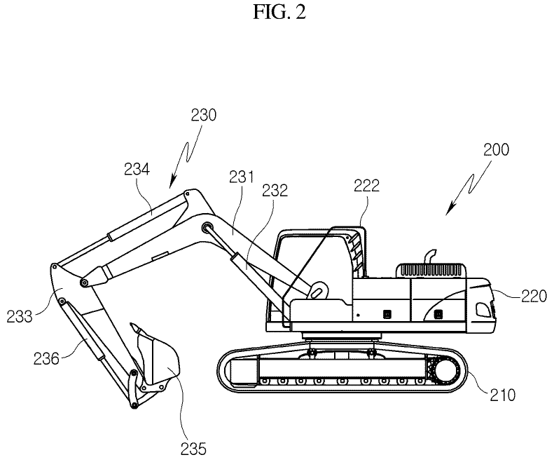

FIG. 2 is a view for explaining the excavator according to various embodiments of the present invention. In the following description, the excavator will be described, for example, among the construction machines illustrated in FIG. 1. However, the construction machine is not limited to the excavator.

With reference to FIG. 2, an excavator 200 may include a lower body 210 configured to serve to move the excavator 200, an upper body 220 mounted on the lower body 210 and configured to rotate by 360 degrees, and a front working device 230 coupled to a front side of the upper body 220. However, this is provided for illustrative purposes only, and the embodiment of the present invention is not limited thereto. For example, in addition to the constituent elements of the excavator 200, one or more other constituent elements (e.g., a plate coupled to a rear side of the lower body 210) may be added.

According to various embodiments, the upper body 220 may have an internal space (not illustrated) in which a cabin 222 in which the operator may be seated and manipulate the cabin may be embedded, and a power generation device (e.g., an engine) may be mounted. The cabin 222 may be provided at a portion close to the operation region. The operation region is a space in which the excavator 200 operates. The operation region is positioned forward of the excavator 200. For example, the seated operator performs the operation below the ensured visual field. In consideration of the position at which the front working device 230 is mounted, the cabin 222 may be positioned at a location biased to one side from the upper body 220 while being adjacent to the operation region, as illustrated in FIG. 2A.

According to various embodiments, the front working device 230 may be a device mounted on an upper surface of the upper body 220 and configured to perform an operation such as an operation of digging in the ground or transporting an object with a heavy load. According to the embodiment, the front working device 230 may include a boom 231 rotatably coupled to the upper body 220, a boom cylinder 232 configured to rotate the boom 231, an arm 233 rotatably coupled to a tip portion of the boom 231, an arm cylinder 234 configured to rotate the arm 233, a bucket 235 rotatably coupled to a tip portion of the arm 233, and a bucket cylinder 236 configured to rotate the bucket 235. During the operation of the excavator 200, one end of the boom 231, one end of the arm 233, and one end of the bucket 235 may individually rotate, such that a region that the bucket 235 may reach may be maximized. Because the front working device 230 is publicly known from many documents, a detailed description thereof will be omitted.

According to various embodiments, the lower body 210 may be coupled to a lower surface of the upper body 220. The lower body 210 may include a traveling body provided as a wheel type using a wheel or a crawler type using an endless track. The traveling body may implement forward, rearward, leftward, and rightward motions of the excavator 200 by using power, which is generated by the power generation device, as driving power. According to the embodiment, the lower body 210 and the upper body 220 may be rotatably coupled by a center joint.

According to various embodiments, the excavator 200 may include a plurality of sensors configured to collect information on the operation of the excavator and/or information on a surrounding environment.

According to the embodiment, the plurality of sensors may include a first sensor configured to detect an operation of the excavator 200. For example, the operation of the excavator 200 may include a rotational operation of the upper body 220 (or the lower body 210). The first sensor may be disposed on the center joint and detect the rotational operation of the upper body 220. In addition, the operation of the excavator 200 may include a rotational operation of the front working device 230. The first sensors may be respectively disposed on the boom 231, the arm 233, and the bucket 235 or disposed on joint parts (e.g., hinge connection portions) of the boom 231, the arm 233, and the bucket 235 and at least detect the rotational operations of the boom 231, the arm 233, and the bucket 235. The position of the first sensor is one embodiment, and the present invention is not limited thereto. The first sensor may be disposed at various positions at which the first sensor may detect a state of the excavator 200.

According to the embodiment, the plurality of sensors may include a second sensor configured to detect the operation region in which the excavator 200 performs the operation. As described above, the operation region may be a space in which the excavator 200 operates, and the operation region may be positioned forward of the excavator 200. The second sensor may be disposed at a portion of the upper body 220 adjacent to the operation region, e.g., the second sensor may be provided on an upper surface of the cabin 222, disposed at one side adjacent to the front working device 230, and configured to detect the operation region. However, this is provided for illustrative purposes only, and the position of the second sensor is not limited thereto. For example, the second sensor may be disposed on the front working device 230, e.g., the arm 233 or the bucket 235 to additionally or selectively detect the operation region.

According to the embodiment, the plurality of sensors may include a third sensor configured to detect an obstacle in the vicinity of the excavator 200. The third sensors may be disposed at a front side, a lateral side, and a rear side of the upper body 220 and detect an obstacle in the vicinity of the excavator 200. The position of the third sensor is one embodiment, and the present invention is not limited thereto. The third sensor may be disposed at various positions at which the third sensor may detect an obstacle in the vicinity of the excavator 200.

According to various embodiments, various sensors described above may include an angle sensor, an inertial sensor, a rotation sensor, an electromagnetic wave sensor, a camera sensor, a radar, a lidar, an ultrasonic sensor, or the like. For example, the first sensor may be configured as at least one of the angle sensor, the inertial sensor, and the rotation sensor. The second sensor and the third sensor may each be configured as at least one of the electromagnetic wave sensor, the camera sensor, the radar, the lidar, and the ultrasonic sensor. For example, camera sensors disposed on the upper surface of the cabin 222 and the arm 233 of the excavator 200 may be used as the second sensors. In addition, the lidar disposed on the front surface of the excavator 200, the ultrasonic sensors disposed on the side surface and the rear surface of the excavator 200, or the camera sensors disposed on the front surface, the side surface, and the rear surface of the excavator 200 may be used as the third sensors. Additionally or selectively, in case that the image sensors are used as the second sensor and the third sensor, the image sensor may be configured as a stereoscopic vision system capable of acquiring images from which the distance information of the object may be recognized.

In addition, the first sensor, the second sensor, and the third sensor may perform operations identical or similar to those of other sensors. For example, the operation of the second sensor, which detects the operation region in which the excavator 200 operates, may be performed by using the third sensor for detecting an obstacle in the vicinity of the excavator 200.

According to various embodiments, the excavator 200 may perform unmanned automation, i.e., an autonomous operation and include at least one positioning device or acquire positioning information from an external device.

According to the embodiment, the positioning device may use a global navigation satellite system (GNSS) module capable of receiving a satellite signal and also use a real time kinematic (RTK) GNSS module for precise measurement. For example, at least one positioning device may be disposed on the upper body 220 of the excavator 200.

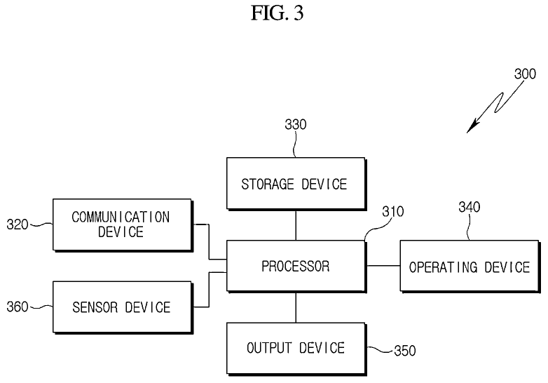

FIG. 3 is a view conceptually illustrating an excavator 300 according to various embodiments of the present invention. The excavator 300 described with reference to FIG. 3 may be the excavator 200 illustrated in FIG. 2.

With reference to FIG. 3, the excavator 300 may include a processor 310, a communication device 320, a storage device 330, an operating device 340, an output device 350, and a sensor device 360. However, this is provided for illustrative purposes only, and the embodiment of the present invention is not limited thereto. For example, at least one of the constituent elements of the excavator 300 may be omitted, or one or more other constituent elements may be added as components of the excavator 300.

According to various embodiments, the communication device 320 may transmit or receive data to or from an external device by using a wireless communication technology. The external device may include the control center 110, another display device (e.g., a smartphone, a notebook, a tablet, or the like) and/or another construction machine. In this case, examples of communication technologies used by the communication device 320 include global system for mobile (GSM) communication, code division multi-access (CDMA), long term evolution (LTE), 5G, wireless LAN (WLAN), Wireless-Fidelity (Wi-Fi), Bluetooth, radio frequency identification (RFID), infrared data association (IrDA), ZigBee, near field communication (NFC), and the like. In addition, as described with reference to FIG. 2, the communication device 320 may include at least one positioning device.

According to various embodiments, the storage device 330 may store various data used by at least one constituent element (e.g., the processor 310, the communication device 320, the operating device 340, the output device 350, or the sensor device 360) of the excavator 300. According to the embodiment, the storage device 330 may store specifications (e.g., model names, unique numbers, and basic specifications), map data, and the like of the excavator 300. According to the embodiment, the storage device 330 may store design drawings based on which the excavator 300 needs to operate. The corresponding design drawings may be immediately stored in the storage device 330 by the user. Alternatively, the excavator 300 may be connected to the control center 110 through the communication device 320, acquire design drawings, and store the design drawings in the storage device 330. Information on some of the design drawings may be displayed on a machine guidance screen to be described below. According to the embodiment, the storage device 330 may include at least one of a non-volatile memory device and a volatile memory device.

According to various embodiments, the operating device 340 may receive instructions or data used to control the operation of the excavator 300. The operating device 340 may include an operating lever for manipulating at least a part (e.g., the boom 231, the arm 233, and the bucket 235) of the front working device 230, a handle for manipulating and steering the lower body 210, and a gear shift lever configured to manipulate a movement speed or forward/rearward traveling of the excavator 300. According to the embodiment, the operating device 340 may be provided in the cabin 222 described above with reference to FIG. 2.

According to various embodiments, the output device 350 may generate an output related to the operation of the excavator 300. According to the embodiment, the output device 350 may include a display configured to output visual information, an audio data output device configured to output auditory information, and haptic module configured to output tactile information. For example, the display may include a liquid crystal display (LCD), a light-emitting diode (LED) display, an organic light-emitting diode (OLED) display, or a micro-electromagnetic system (MEMS) display, an electronic paper, or the like. In addition, the audio data output device may be included in the excavator 300 or include at least one of a speaker, an earphone, an earset, or a headset connected to the excavator 300 in a wired/wireless manner.

According to various embodiments, the sensor device 360 may include the first sensor configured to detect the operation of the excavator 300, the second sensor configured to detect the operation region in which the excavator 300 performs the operation, and/or the third sensor configured to detect an obstacle in the vicinity of the excavator 300. In addition, sensors required to manage the excavator 300 may be added.

According to various embodiments, the processor 310 may be configured to control overall operations of the excavator 300. According to the embodiment, the processor 310 may perform various types of data processing or computation and control at least one of the constituent elements (e.g., the communication device 320, the storage device 330, the operating device 340. the output device 350, or the sensor device 360) connected to the processor 310 by executing software (e.g., program) stored in the storage device 330. For example, as at least a part of data processing or computation, the processor 310 may store instructions or data, which are received from another constituent element, in the storage device 330, process the instructions or data stored in the storage device 330, and store the resulting data in the storage device 330. The processor 310 may include a main processor, and an auxiliary processor that operates independently of or together with the main processor. According to the embodiment, the processor 310 may perform controller area network (CAN) communication with the above-mentioned constituent element (e.g., the communication device 320, the storage device 330, the operating device 340, the output device 350, or the sensor device 360). However, the present disclosure is not limited thereto.

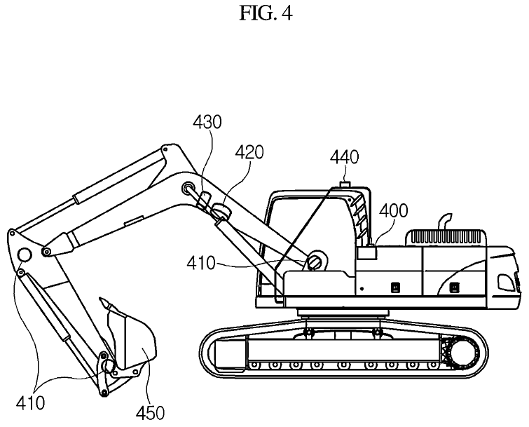

FIG. 4 is a view illustrating constituent elements that may be added to the excavator to implement a light guide system according to various embodiments of the present invention.

With reference to FIG. 4, the light guide system provided in the excavator 200 according to various embodiments may include an angle sensor 410, a projection module 420, an image capturing module 430, an illuminance sensor 440, and a light guide device 400. In this case, the image capturing module 430 and the illuminance sensor 440 may be additionally included.

According to various embodiments, the light guide device 400 may be configured as a separate independent device and positioned by being coupled to the excavator 200 or positioned by being separated from the excavator 200. Sensors provided in the excavator 200 in the related art may be used as the angle sensor 410, the image capturing module 430, and the illuminance sensor 440. Alternatively, sensors may be additionally provided in the excavator 200 to constitute the light guide system. The projection module 420 may be additionally provided in the excavator 200 to constitute the light guide system.

According to various embodiments, the angle sensor 410 may be disposed on the joint part of the excavator 200 and sense an angle of the joint part of the excavator 200. The angle sensor 410 may be one of the first sensors described with reference to FIG. 2.

The angle sensor 410 may sense the angle of the joint part of the excavator 200 in a preset cycle or in response to an angle sensing signal transmitted by the light guide device 400, and the angle sensor 410 may output the sensed angle of the joint part of the excavator 200.

The angle sensor 410 may be disposed on each of the joint parts of the excavator 200 and sense the angle of each of the joint parts of the excavator 200, and the angle sensor 410 may output the sensed angle of each of the joint parts of the excavator 200.

The angle sensor 410 may create sensing data of the angle of the joint part of the excavator 200 for each of the joint parts of the excavator 200 based on the sensed angle of each of the joint parts of the excavator 200, and the angle sensor 410 may output the created sensing data of the angle of the joint part of the excavator 200.

According to various embodiments, the projection module 420 may implement a projected object on an operation surface by using light.

The projection module 420 may be positioned at an upper end of the cabin 222, the boom 231, or the like of the excavator 200. The location on the excavator 200 at which the projection module 420 may be positioned is not limited thereto.

The projection module 420 may implement the projected object by means of light (e.g., colored light, laser beams, or the like) with a preset wavelength based on a shape of a determined projected object. In this case, the shape of the projected object may correspond to a shape of an attachment 450. However, the shape of the projected object is not limited thereto. In this case, the preset wavelength may vary depending on operation positions, weather of the workplace, humidity of the workplace, pressure of the workplace, or the like.

The projection module 420 may implement the projected object by means of light with the preset wavelength (e.g., light with a wavelength included in wavelength data) based on projected object shape data and wavelength data transmitted by the light guide device 400.

The projection module 420 may project the projected object, which is implemented by the light with the preset wavelength, onto a position corresponding to a position of the attachment 450. In this case, the position corresponding to the position of the attachment 450 may be a vertically lower side of the position of the attachment 450. However, the position onto which the projected object is projected by the projection module 420 is not limited thereto.

The projection module 420 may project the projected object, which is implemented by the light with the preset wavelength, onto the position of the attachment 450 and the operation position at which the attachment 450 is to perform the operation. In this case, the projection module 420 may project light beams with different wavelengths (light beams with different colors) onto the position of the attachment 450 and the operation position.

The projection module 420 may project the projected object, which is implemented by the light with the preset wavelength, onto a preset position (e.g., a position of an object that the excavator operator needs to pay attention to).

The projection module 420 may project the projected object, which is implemented by the light with the preset wavelength, onto the position corresponding to the position of the attachment 450 based on a control signal transmitted by the light guide device 400. In this case, the position corresponding to the position of the attachment 450 may be the vertically lower side of the position of the attachment 450. However, the position corresponding to the position of the attachment 450 is not limited thereto.

The projection module 420 may project the projected object, which is implemented by the light with the preset wavelength, onto the position corresponding to the position of the attachment 450 and the operation position at which the attachment 450 is to perform the operation based on a control signal transmitted by the light guide device 400. In this case, the projection module 420 may project light beams with different wavelengths (light beams with different colors) onto the position of the attachment 450 and the operation position.

The projection module 420 may project the projected object, which is implemented by the light with the preset wavelength, onto a preset position (e.g., a position of an object that the excavator operator needs to pay attention to) based on the control signal transmitted by the light guide device 400.

The projection module 420 may change a wavelength, an intensity, or the like of the light for implementing the projected object based on the control signal transmitted by the light guide device 400.

The projection module 420 may change the wavelength, the intensity, or the like of the light for implementing the projected object based on data related to the amount of light in the vicinity of the excavator 200 outputted by an illuminance sensor 240.

According to various embodiments, the image capturing module 430 may capture images of a periphery of the excavator 200 in response to an image capturing signal transmitted by the light guide device 400, and the image capturing module 430 may output acquired image data at the periphery of the excavator 200.

According to various embodiments, the illuminance sensor 240 may acquire the data related to the amount of light of the periphery of the excavator 200 and output the acquired data related to the amount of light at the periphery of the excavator 200.

According to various embodiments, the light guide device 400 may be positioned at the upper end of the cabin 222, the boom 231, or the like of the excavator 200. However, the location on the excavator 200 at which the light guide device 400 may be positioned is not limited thereto.

The light guide device 400 may be communicatively connected to the angle sensor 410, the projection module 420, an image capturing module 230, and the illuminance sensor 240 included in the excavator 200.

The light guide device 400 may be connected to the angle sensor 410, the projection module 420, the image capturing module 430, and the illuminance sensor 440 included in the excavator 200 and mutually transmit data.

The light guide device 400 may determine the position of the attachment 450 included in the excavator 200 based on the sensing data of the angle of the joint part of the excavator 200 outputted by the angle sensor 410 included in the excavator 200.

The light guide device 400 may determine the types of attachments 450 (e.g., a bucket, a clamshell, a breaker, a soil compactor, a crane, a dragline, pincers, a hammer, and the like) attached to the tip of the front working device 230 of the excavator 200 based on an input or the like of the operator of the excavator 200.

According to the embodiment, the light guide device 400 may determine the type of the attachment 450 attached to the tip of the front working device 230 by searching for the type of attachment from a preset database or the storage device 330 based on the input or the like of the operator of the excavator 200.

The light guide device 400 may determine the shape of the projected object corresponding to the shape of the attachment 450 based on the determined attachment 450. According to the embodiment, the light guide device 400 may determine the shape of the projected object corresponding to the shape of the attachment 450 by searching for the shape of the projected object from the preset database or the storage device 330 based on the determined attachment 450.

The light guide device 400 may create projected object shape data based on the determined shape of the projected object.

The light guide device 400 may create wavelength data by determining the wavelength of the light for implementing the projected object. In this case, the wavelength of the light for implementing the projected object may vary depending on operation positions, weather of the workplace, humidity of the workplace, pressure of the workplace, or the like.

The light guide device 400 may change the wavelength, the intensity, or the like of the light for implementing the projected object based on data related to the amount of light in the vicinity of the excavator 200 acquired by the illuminance sensor 240.

The light guide device 400 may transmit the created projected object shape data and/or the created wavelength data to the projection module 420.

The light guide device 400 may acquire workplace drawing information (e.g., terrain information of the workplace or the like), operation information (e.g., a workplace position, an operation order, or the like), workplace weather information, and the like based on the input of the operator of the excavator 200, GPS information, weather forecast information, and the like.

The light guide device 400 may determine the operation surface, the operation order, or the position at which the operation needs to be performed on the operation surface based on the acquired workplace drawing information, operation information, workplace weather information, and the like.

The light guide device 400 may generate a control signal based on the operation order or the position at which the operation needs to be performed on the determined operation surface.

The light guide device 400 may control the projection module 420 to project the projected object, which is implemented by means of light with the wavelength preset by the projection module 420 by using the generated control signal or light with the wavelength (e.g., the wavelength included in the wavelength data) set based on the projected object shape data and the wavelength data transmitted by the light guide device 400, onto the position corresponding to the position of the attachment 450. In this case, the position corresponding to the position of the attachment 450 may be the vertically lower side of the position of the attachment 450. However, the position corresponding to the position of the attachment 450 is not limited thereto.

The light guide device 400 may control the projection module 420 to project the projected object, which is implemented by means of light with the wavelength preset by the projection module 420 by using the generated control signal or light with the wavelength (e.g., the wavelength included in the wavelength data) set based on the projected object shape data and the wavelength data transmitted by the light guide device 400, onto the position of the attachment 450 and the operation position at which the attachment 450 is to perform the operation. In this case, the light guide device 400 may set light beams with different wavelengths for the operation position and the position of the attachment 450.

The light guide device 400 may control the projection module 420 to project the projected object, which is implemented by means of light with the wavelength preset by the projection module 420 by using the generated control signal or light with the wavelength (e.g., the wavelength included in the wavelength data) set based on the projected object shape data and the wavelength data transmitted by the light guide device 400, onto the preset position (e.g., the position of the object that the operator needs to pay attention to at the periphery of the excavator 200).

The light guide device 400 may correct the position corresponding to the position of the attachment 450 or the operation position at which the attachment 450 is to perform the operation, onto which the projected object is projected by the projection module 420, based on the acquired workplace drawing information (e.g., the terrain information of the workplace or the like), the acquired operation information (e.g., the workplace position, the operation order, or the like), the acquired workplace weather information, and the like. In this case, the position corresponding to the position of the attachment 450 may be the vertically lower side. However, the position corresponding to the position of the attachment 450 is not limited thereto.

According to various embodiments, the light guide device 400 may generate an image capturing signal for controlling an overall image capturing configuration such as image capturing initiation, an image capturing angle, an image capturing resolution, an image capturing depth, and the like. The light guide device 400 may transmit the generated image capturing signal to the image capturing module 430.

The light guide device 400 may acquire image data at the periphery of the excavator 200 acquired by the image capturing module 430.

The light guide device 400 may display the acquired image data of the periphery of the excavator 200 on a preset screen. In this case, the preset screen may be a screen provided in an operator seat 222 so that the operator may directly identify the screen, a screen provided at a location at which the excavator 200 may be operated or controlled remotely, a screen of a head-mounted display (HMD) worn by the operator to operate or control the excavator 200 remotely, or a screen of a workplace control tower for overseeing the workplace. However, the preset screen is not limited thereto.

It will be apparent to those skilled in the art to which the present invention belongs that the term “device or module” as used herein refers to a logical unit of organization and not necessarily to physically distinct components.

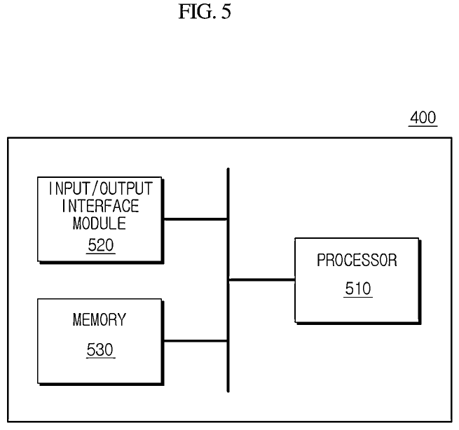

FIG. 5 is a view illustrating a configuration of the light guide device according to various embodiments of the present invention.

With reference to FIG. 5, the light guide device 400 according to various embodiments may include a processor 510, an input/output interface module 520, and a memory 530.

According to various embodiments, the processor 510, the input/output interface module 520, and the memory 530 included in the light guide device 400 may be connected to one another and mutually transmit data.

According to various embodiments, the processor 510 may execute programs or instructions stored in the memory 530. In this case, an operation program (e.g., OS) for operating the light guide device 400 may be stored in the memory 530.

The processor 510 may execute a program for managing information for the light guide device 400.

The processor 510 may execute a program for managing the operation of the light guide device 400.

The processor 510 may execute a program for managing the operation of the input/output interface module 520.

The processor 510 may be communicatively connected to the angle sensor, the projection module, the image capturing module, and the illuminance sensor included in the excavator 200 through the input/output interface module 520.

The processor 510 may be connected to the angle sensor, the projection module, the image capturing module, and the illuminance sensor included in the excavator 200 through the input/output interface module 520 and mutually transmit data.

The processor 510 may generate an angle sensing signal for allowing the angle sensor 410 to initiate sensing of the angle of the joint part of the excavator 200.

The processor 510 may transmit the generated angle sensing signal to the angle sensor 410 through the input/output interface module 520.

The processor 510 may determine the position of the attachment 450 based on the sensing data of the angle of the joint part of the excavator 200 outputted by the angle sensor 410 included in the excavator 200.

The processor 510 may determine the type of the attachment 450 based on the input of the operator of the excavator 200 for the input/output interface module 520.

According to various embodiments, the processor 510 may determine the type of the attachment 450 by searching for the attachment 450 from the memory 530 based on the input of the operator or the like.

According to various embodiments, the processor 510 may determine the type of the attachment 450 by searching for the attachment 450 from the preset database connected through the input/output interface module 520 based on the input of the operator or the like for the input/output interface module 520.

The processor 510 may determine the shape of the projected object corresponding to the shape of the attachment 450 based on the determined attachment 450.

The processor 510 may determine the shape of the projected object corresponding to the shape of the attachment 450 by searching for the shape of the projected object of the attachment 450 from the memory 530 based on the input of the operator or the like.

The processor 510 may determine the shape of the projected object corresponding to the shape of the attachment 450 by searching for the shape of the projected object from the preset database connected through the input/output interface module 520 based on the determined attachment 450.

The processor 510 may create projected object shape data based on the determined shape of the projected object.

The processor 510 may create wavelength data by determining the wavelength of the light for implementing the projected object.

In this case, the wavelength of the light for implementing the projected object may vary depending on operation positions, weather of the workplace, humidity of the workplace, pressure of the workplace, or the like.

The processor 510 may change the wavelength, the intensity, or the like of the light for implementing the projected object based on data related to the amount of light in the vicinity of the excavator 200 acquired by the illuminance sensor 240.

The processor 510 may transmit the created projected object shape data and/or the created wavelength data to the projection module 420 through the input/output interface module 520.

The processor 510 may acquire workplace drawing information (e.g., terrain information of the workplace or the like), operation information (e.g., a workplace position, an operation order, or the like), workplace weather information, and the like based on the input of the operator of the excavator 200, GPS information, weather forecast information, and the like received through the input/output interface module 520.

The processor 510 may determine the operation surface, the operation order, or the position at which the operation needs to be performed on the operation surface based on the acquired workplace drawing information, operation information, workplace weather information, and the like.

The processor 510 may generate a control signal based on the operation order or the position at which the operation needs to be performed on the determined operation surface.

The processor 510 may control the projection module 420 to project the projected object, which is implemented by means of light with the wavelength preset by the projection module 420 by using the generated control signal or light with the wavelength (e.g., the wavelength included in the wavelength data) set based on the projected object shape data and the wavelength data transmitted by the processor 510 through the input/output interface module 520, onto the position corresponding to the position of the attachment 450. In this case, the position corresponding to the position of the attachment 450 may be the vertically lower side of the position of the attachment 450. However, the position corresponding to the position of the attachment 450 is not limited thereto.

The processor 510 may control the projection module 420 to project the projected object, which is implemented by means of light with the wavelength preset by the projection module 420 by using the generated control signal or light with the wavelength (e.g., the wavelength included in the wavelength data) set based on the projected object shape data and the wavelength data transmitted by the processor 510 through the input/output interface module 520, onto the position of the attachment 450 and the operation position at which the attachment 450 is to perform the operation. In this case, the light guide device 400 may set light beams with different wavelengths for the operation position and the position of the attachment 450.

According to various embodiments, the processor 510 may control the projection module 420 to project the projected object, which is implemented by means of light with the wavelength preset by using the generated control signal or light with the wavelength (e.g., the wavelength included in the wavelength data) set based on the projected object shape data and the wavelength data transmitted by the processor 510 through the input/output interface module 520, onto the preset position (e.g., the position of the object that the operator of the excavator 200 needs to pay attention to).

According to various embodiments, the processor 510 may correct the position corresponding to the position of the attachment 450 or the operation position at which the attachment 450 is to perform the operation, onto which the projected object is projected by the projection module 420, based on the workplace drawing information (e.g., the terrain information of the workplace or the like), the operation information (e.g., the workplace position, the operation order, or the like), the workplace weather information, and the like that are acquired through the input/output interface module 520. In this case, the position corresponding to the position of the attachment 450 may be the vertically lower side. However, the position corresponding to the position of the attachment 450 is not limited thereto.

According to various embodiments, the processor 510 may generate the image capturing signal for controlling the overall image capturing configuration such as the image capturing initiation, the image capturing angle, the image capturing resolution, the image capturing depth, and the like. The processor 510 may transmit the image capturing signal, which is generated through the input/output interface module 520, to the image capturing module 430.

The processor 510 may acquire the image data at the periphery of the excavator 200 acquired by the image capturing module 430 through the input/output interface module 520.

The processor 510 may display the image data at the periphery of the excavator 200 acquired through the input/output interface module 520 on the preset screen through the input/output interface module 520. In this case, the preset screen may be a screen provided in the operator seat 222 so that the operator may directly identify the screen, a screen provided at a location at which the excavator 200 may be operated or controlled remotely, a screen of a head-mounted display (HMD) worn by the operator of the excavator 200 to operate or control the excavator 200 remotely, or a screen of a workplace control tower for overseeing the workplace. However, the preset screen is not limited thereto.

The processor 510 may detect a change in size or shape of the attachment 450 through the input/output interface module 520. The processor 510 may change the shape of the projected object in response to the detected change in size or shape of the attachment 450. The processor 510 may create new projected object shape data based on the changed shape of the projected object. The processor 510 may transmit the new projected object shape data generated through the input/output interface module 520 to the projection module.

The processor 510 may generate a new control signal corresponding to the new projected object shape data. The processor 510 may transmit the new control signal generated through the input/output interface module 520 to the projection module 430.

The processor 510 may control the projection module 430 to project the changed projected object, which is implemented by means of light with a wavelength preset by the projection module 430 by using the generated new control signal, onto the position corresponding to the position of the attachment 450. In this case, the position corresponding to the position of the attachment 450 may be the vertically lower side of the position of the attachment 450. However, the position corresponding to the position of the attachment 450 is not limited thereto.

According to various embodiments, the input/output interface module 520 may be connected to the external devices (e.g., the angle sensor, the projection module, the image capturing module, the illuminance sensor, the working machine database, the projection database, and the like).

The input/output interface module 520 may acquire data (e.g., the sensing data of the angle of the joint part of the excavator 200, global positioning system (GPS) information, weather forecast information, workplace drawing information, operation information, workplace weather information, image data at the periphery of the excavator 200, and the like) from the external device.

The input/output interface module 520 may transmit the data to the external devices (e.g., the projection module 420, the image capturing module 430, the screen for remotely operating or controlling the excavator 200, the head-mounted display worn by the operator, the screen of the control tower, and the like).

The input/output interface module 520 may output the projected object shape data created by the processor 510.

The input/output interface module 520 may output the wavelength data created by the processor 510.

The input/output interface module 520 may output the control signal generated by the processor 510.

The input/output interface module 520 may output the image capturing signal generated by the processor 510.

The input/output interface module 520 may output the angle sensing signal generated by the processor 510.

The input/output interface module 520 may acquire the user's input.

The input/output interface module 520 may include a port (e.g., a USB port) connected to the external device.

The input/output interface module 520 may be connected to a monitor, a touch screen, a mouse, an electronic pen, a microphone, a keyboard, a speaker, an earphone, a headphone, or a touch pad.

According to various embodiments, the memory 530 may store the data acquired through the input/output interface module 520.

The memory 530 may store the data transmitted through the input/output interface module 520.

The memory 530 may store the data outputted through the input/output interface module 520.

The memory 530 may store the position of the attachment 450 determined by the processor 510.

The memory 530 may store the user's input.

The memory 530 may store information on various attachments 450.

The memory 530 may store the shape of the projected object.

The memory 530 may store the attachment 450 determined by the processor 510.

The memory 530 may store the shape of the projected object determined by the processor 510.

The memory 530 may store the operation order or the position at which the processor 510 needs to operate on the operation surface.

The memory 530 may store the angle sensing signal generated by the processor 510.

The memory 530 may store the control signal generated by the processor 510.

The memory 530 may store the image capturing signal generated by the processor 510.

The memory 530 may store the position corresponding to the position of the attachment 450 determined by the processor 510 or the operation position at which the attachment 450 needs to perform the operation.

The memory 530 may store an application program.

It will be apparent to those skilled in the art to which the present invention belongs that the term “device or module” as used herein refers to a logical unit of organization and not necessarily to physically distinct components.

In the above-mentioned description with reference to FIGS. 4 and 5, the light guide device 400 has been described as being configured separately and provided in the excavator 200. However, the light guide device 400 may be embedded in the excavator 200. For example, the functions of the processor 510 and the input/output interface module 520 of the light guide device 400 may be performed by the processor 310 of the excavator 300. In this case, the input/output interface module 520 may be connected to the communication device 320, the sensor device 360, the output device 350, and/or the operating device 340. Further, the function of the memory 530 of the light guide device 400 may be performed by the storage device 330. In the embodiment, the light guide device 400 may be implemented as one function implemented by the hardware constituent element provided in the excavator 200 without being present as a separate device.

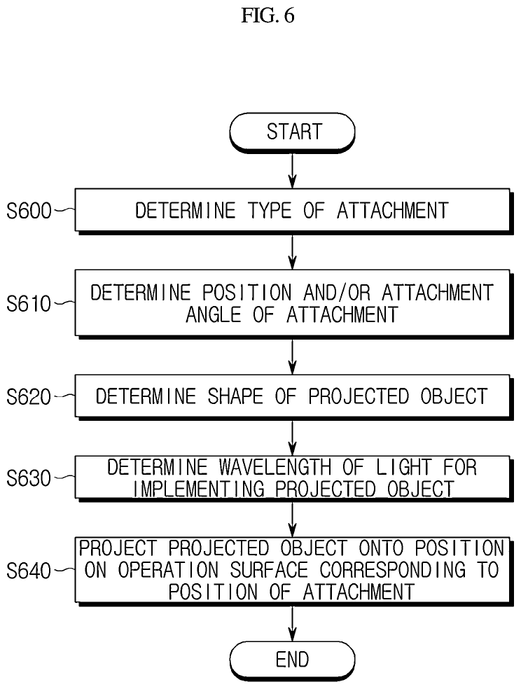

FIG. 6 is a flowchart illustrating a light guide method according to the embodiment of the present invention.

With reference to FIG. 6, the light guide method may include operation S600 of determining the type of the attachment 450 by the light guide device 400, operation S610 of determining the position and/or attachment angle of the attachment 450, operation S620 of determining the shape of the projected object, operation S630 of determining the wavelength of the light for implementing the projected object, and operation S640 of projecting the projected object onto the position on the operation surface corresponding to the position of the attachment 450.

At operation S600, the light guide device 400 may determine the type of the attachment 450 attached to the excavator 200 based on the input of the operator or manager.

According to the embodiment, the light guide device 400 may determine the type of the attachment 450 attached to the excavator 200 by searching for the attachment 450 from the memory 510 included in the light guide device 400 based on the input of the operator or manager or the like.

According to another embodiment, the light guide device 400 may determine the type of the attachment 450 attached to the excavator 200 by searching for the attachment 450 from the preset database based on the input of the operator or manager or the like.

At operation S610, the light guide device 400 may determine the position and/or attachment angle of the attachment 450 attached to the excavator 200.

According to the embodiment, the light guide device 400 may generate the angle sensing signal for allowing the angle sensor 410 included in the excavator 200 to initiate sensing of the angle of the joint part of the excavator 200 and transmit the generated angle sensing signal to the angle sensor 410. The angle sensor 410 may acquire the sensing data of the angle of the joint part of the excavator 200 based on the received angle sensing signal and provide the sensing data to the light guide device 400.

According to another embodiment, the angle sensor 410 may acquire the sensing data of the angle of the joint part of the excavator 200 in a preset cycle and provide the sensing data to the light guide device 400.

The light guide device 400 may determine the position and/or attachment angle of the attachment 450 provided in the excavator 200 based on the sensing data of the angle of the joint part of the excavator 200 provided by the angle sensor 410 included in the excavator 200.

At operation S620, the light guide device 400 may determine the shape of the projected object based on the determined type of the attachment 450 and/or the determined attachment angle of the attachment 450.

According to the embodiment, the light guide device 400 may perform the determination by searching for the shape of the projected object corresponding to the attached attachment 450 from the memory 510 among the shapes of the projected object stored in advance through the input of the operator or manager or the like.

According to another embodiment, the light guide device 400 may determine the shape of the projected object corresponding to the attached attachment 450 by searching for the shape of the projected object from the preset database from the outside based on the determined attachment 450.

According to another embodiment, the light guide device 400 may determine the shape of the attachment 450, which is viewed from the vertically lower side, as the shape of the projected object. In this case, the shape of the projected object may vary depending on the type and attachment angle of the attached attachment 450.

At operation S630, the light guide device 400 may determine the wavelength of the light for implementing the projected object.

The light guide device 400 may determine the wavelength, the intensity, or the like of the light for implementing the projected object based on data related to the amount of light in the vicinity of the excavator 200 acquired by the illuminance sensor. In addition, the light guide device 400 may determine the wavelength, the intensity, or the like of the light for implementing the projected object additionally in consideration of the operation position, the weather of the workplace, the humidity of the workplace, the pressure of the workplace, and the like.

Further, the wavelength data including the determined wavelength and/or intensity information may be created. The light guide device 400 may additionally perform this operation. According to the embodiment, in case that the wavelength used for the projection module 420 is set in advance, the light guide device 400 may not perform operation S630.

At operation S640, the light guide device 400 may project the projected object onto the position on the operation surface corresponding to the position of the attachment 450.

The light guide device 400 may acquire workplace drawing information (e.g., terrain information of the workplace or the like), operation information (e.g., a workplace position, an operation order, or the like), workplace weather information, and the like based on the input of the operator or manager, GPS information, weather forecast information, and the like.

The light guide device 400 may determine the operation surface based on the acquired workplace drawing information, operation information, workplace weather information, and the like.

The light guide device 400 may create information on a region in which the projected object is projected onto the operation surface determined based on the position of the attachment 450, the shape of the projected object, and the like. According to the embodiment, the region in which the projected object is to be projected may be a position on the operation surface corresponding to the vertically lower side of the position of the attachment 450 attached to the excavator 200.

According to the embodiment, when the shape of the projected object is a shape when the attachment 450 is viewed front vertically lower side, the region in which the projected object is to be projected may be a region on the operation surface provided at the vertically lower side of the attachment 450.

According to another embodiment, when the shape of the projected object is determined as any shape instead of the shape when the attachment 450 is viewed from the vertically lower side, the region in which the projected object is to be projected may be a region in which the projected object, which is determined based on the position on the operation surface corresponding to the vertically lower side of the position of the attachment 450, may be projected.

The light guide device 400 may generate a control signal including information on the determined shape of the projected object, the wavelength of the light for implementing the projected object, and/or the region in which the projected object is to be projected, and the light guide device 400 may transfer the information to the projection module 420.

The projection module 420 may project the projected object in the region the light with the preset wavelength or the wavelength included in the control signal is projected based on the control signal received from the light guide device 400.

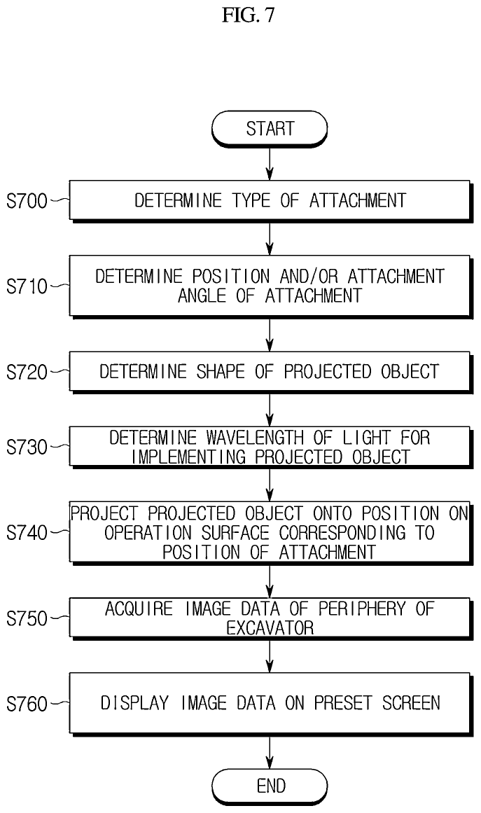

FIG. 7 is a flowchart illustrating a light guide method according to another embodiment.

With reference to FIG. 7, the light guide method may include operation S700 of determining the type of the attachment 450 by the light guide device 400, operation S710 of determining the position and/or attachment angle of the attachment 450, operation S720 of determining the shape of the projected object, operation S730 of determining the wavelength of the light for implementing the projected object, operation S740 of projecting the projected object onto the position on the operation surface corresponding to the position of the attachment 450, operation S750 of acquiring the image data of the periphery of the excavator 200, and operation S760 of displaying the image data on the preset screen.

In this case, because operations S700, S710, S720, S730, and S740 may be identical to operations S600, S610, S620, S630, and S640 described with reference to FIG. 6, a detailed description thereof will be replaced with the description described with reference to FIG. 6 and omitted.

At operation S750, in order to acquire the image data of the periphery of the excavator, the light guide device 400 may generate an image capturing control signal for controlling the overall image capturing configuration such as the image capturing initiation, the image capturing angle, the image capturing resolution, and the image capturing depth and transmit the generated image capturing control signal to the image capturing module 430.

The image capturing module 430 may acquire the image data of the periphery of the excavator 200 based on the image capturing control signal and transmit the image data to the light guide device 400. The light guide device 400 may acquire image data at the periphery of the excavator 200 provided by the image capturing module 430.

At operation S760, the light guide device 400 may display the acquired image data of the periphery of the excavator 200 on a preset screen.

The preset screen may be a screen provided in the operator seat 222 so that the operator may directly identify the screen when the operator in the operator seat 222 directly operates the excavator 200, a screen provided so that the operator may directly identify the screen from the remote place when the operator remotely operates or controls the excavator 200, a screen of a head-mounted display (HMD) worn by the operator of the excavator 200 to operate or control the excavator 200 remotely, or a screen of a workplace control tower for overseeing the workplace. However, the preset screen is not limited thereto.

According to another embodiment, in the light guide method illustrated in FIG. 7, the operation of transmitting the control signal to the image capturing module 430 and displaying the image data of the periphery of the excavator 200 on the preset screen may be performed by another function of the excavator 200 independently of the light guide method illustrated in FIG. 6. In this case, the operation of displaying the image data of the periphery of the excavator 200 on the screen may be always performed by another excavator application independently of the light guide method in FIG. 6.

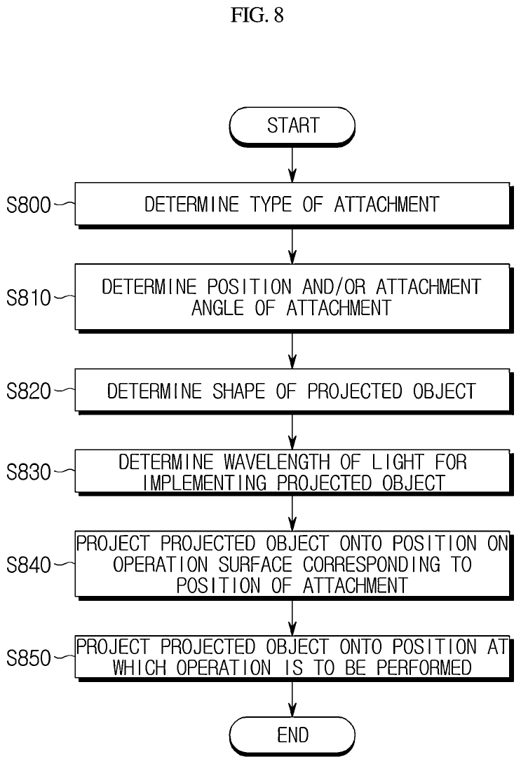

FIG. 8 is a flowchart illustrating a light guide method according to still another embodiment.

With reference to FIG. 8, the light guide method may include operation S800 of determining the type of the attachment 450 by the light guide device 400, operation S810 of determining the position and/or attachment angle of the attachment 450, operation S820 of determining the shape of the projected object, operation S830 of determining the wavelength of the light for implementing the projected object, operation S840 of projecting the projected object onto the position on the operation surface corresponding to the position of the attachment 450, and operation S850 of projecting the projected object onto the position at which the operation is to be performed on the operation surface.

In this case, because operations S800, S810, S820, S830, and S840 may be identical to operations S600, S610, S620, S630, and S640 described with reference to FIG. 6, a detailed description thereof may be replaced with the description described with reference to FIG. 6.

At operation S850, the light guide device 400 may determine the operation surface and the position at which the attachment 450 is to operate based on the workplace drawing information, operation information, workplace weather information, and the like acquired at operation S840 (operation S640). Further, the light guide device 400 may generate a control signal including additional information that allows the projected object to be projected even onto the position at which the operation is to be performed, and the light guide device 400 may transmit the control signal to the projection module 420.

In this case, the additional information may include the wavelength or intensity of the light for implementing the projected object on the position at which the operation is to be performed.

To this end, at operation S830, the light guide device 400 may determine a second wavelength of light for implementing the projected object onto the position at which the operation is to be additionally performed while determining a first wavelength at operation S630, and the control signal may include first wavelength information and second wavelength information. The first wavelength and the second wavelength may be different from each other.

In addition, the shapes of the projected objects projected onto the positions at which the operations are to be performed may be identical to one another. However, according to another embodiment, the shapes of the projected objects may also be different from one another. In this case, at operation S820, the light guide device 400 may additionally determine a second shape of the projected object to be projected onto the position at which the operation is to be performed.

According to another embodiment, the wavelength of the light to be projected by the projection module 420 may be set in advance to the projection module. In this case, the light guide device 400 may select the first wavelength of the light projected onto the position on the operation surface corresponding to the position of the attachment 450 or the second wavelength of the light projected onto the position at which the operation is to be performed and include the selected wavelength in the control signal.

According to another embodiment, the first wavelength and the second wavelength may be set in advance to the projection module 420. In this case, the light guide device 400 may not include information on the first wavelength and the second wavelength in the control signal.

The projection module 420 may project the first projected object by means of the light with the first wavelength onto the position on the operation surface corresponding to the attachment position at operation S840 and simultaneously project the second projected object by means of the light with the second wavelength onto the position at which the operation is to be performed based on the control signal received from the light guide device 400.

According to another embodiment, while operations are disclosed in different embodiments, the operations of acquiring the image data of the periphery of the excavator in FIG. 7 (operation S750), displaying the acquired image data on the preset screen (operation S760), and projecting the projected object onto the position at which the operation in FIG. 8 is to be performed (operation S850) may be independent operations and performed together in one embodiment. With this operation, the operator may simultaneously recognize the projected object, which indicates the operation surface corresponding to the position of the current attachment on one screen, and the projected object that indicates the position at which the operation is to be performed. Therefore, it is possible to easily performing the operation of adjusting the position of the attachment so that the projected object indicating the attachment and the projected object indicating the position at which the operation is to be performed may be consistent with each other, thereby improving the working efficiency.

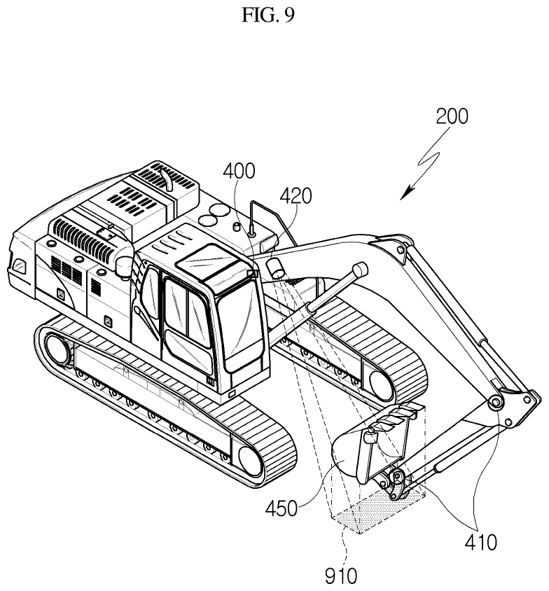

FIG. 9 is a view illustrating a state in which the light guide device according to the embodiment of the present invention projects light onto the vertically lower side of an attachment in a shape corresponding to a shape of the attachment.

With reference to FIG. 9, the excavator 200 according to various embodiments may include the light guide device 400, the angle sensor 410, and the projection module 420. In the present embodiment, the excavator 200 may not include the image capturing module 430 and the illuminance sensor 440.

The light guide device 400 may determine the type of the attachment 450 attached to the excavator 200 based on the input of the operator or manager or the like and determine the position and/or attachment angle of the attachment 450 based on the angle of the joint part of the excavator 200 sensed and transmitted by the angle sensor 410 and the type of the attachment 450.

The light guide device 400 may determine the shape of the projected object based on the determined type of the attachment 450 and/or the determined attachment angle of the attachment 450. In the embodiment in FIG. 9, the light guide device 400 may determine the shape of the attachment 450, which is viewed from the vertically lower side, as a shape of a projected object 910.

In addition, the light guide device 400 may determine information on the wavelength and/or intensity of the light for implementing the projected object.

In addition, the light guide device 400 may determine the operation surface and determine the position on the operation surface onto which the projected object is projected. According to the embodiment, the light guide device 400 may determine the position, at which the attachment 450 is vertically projected onto the operation surface, as a position onto which the projected object is projected.

The light guide device 400 may transmit the control signal, which includes information on the shape of the projected object, the position at which the projected object is to be projected onto the operation surface, and the wavelength and/or intensity of the light for implementing the projected object, to the projection module 420, and the projection module 420 may project the projected object 910 onto the vertically lower side of the attachment 450 based on the received control signal, as illustrated in FIG. 9.

It will be apparent to those skilled in the art to which the present invention belongs that the term “device or module” as used herein refers to a logical unit of organization and not necessarily to physically distinct components.

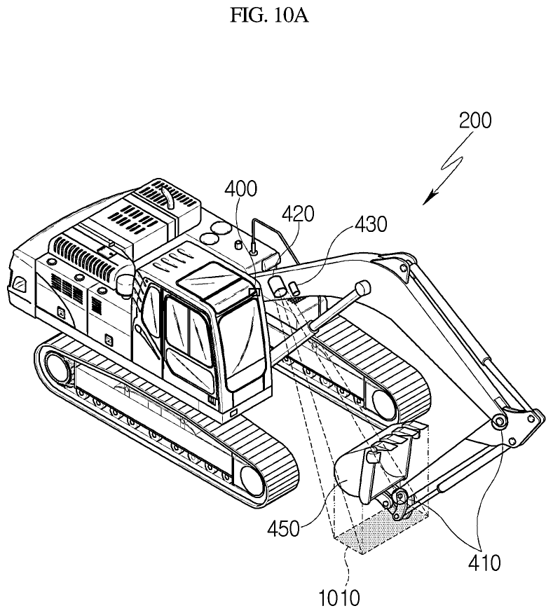

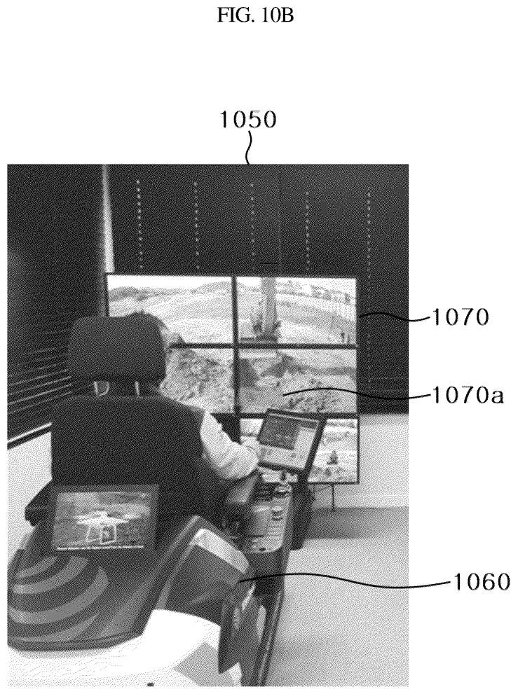

FIGS. 10A and 10B are views illustrating a state in which image data, which are related to a periphery of the excavator including the state in which the light guide device according to the embodiment projects light onto the vertically lower side of the attachment in the shape corresponding to the shape of the attachment, are displayed on a screen of an operator positioned remotely.

With reference to FIG. 10A, the excavator according to various embodiments may include the light guide device 400, the angle sensor 410, the projection module 420, and the image capturing module 430.

The light guide device 400 may determine the type of the attachment 450 attached to the excavator 200 based on the input of the operator or manager or the like and determine the position and/or attachment angle of the attachment 450 based on the angle of the joint part of the excavator 200 sensed and transmitted by the angle sensor 410 and the type of the attachment 450.

The light guide device 400 may determine the shape of the projected object based on the determined type of the attachment 450 and/or the determined attachment angle of the attachment 450. In the embodiment in FIG. 9, the light guide device 400 may determine the shape of the attachment 450, which is viewed from the vertically lower side, as a shape of a projected object 910.

In addition, the light guide device 400 may determine information on the wavelength and/or intensity of the light for implementing the projected object.

In addition, the light guide device 400 may determine the operation surface and determine the position on the operation surface onto which the projected object is projected.

The light guide device 400 may transmit the control signal, which includes information on the shape of the projected object, the position at which the projected object is to be projected onto the operation surface, and the wavelength and/or intensity of the light for implementing the projected object, to the projection module 420, and the projection module 420 may project the projected object 1010 onto the vertically lower side of the attachment 450 based on the received control signal, as illustrated in FIG. 10A.

Additionally, the light guide device 400 may acquire the image data of the periphery of the excavator in accordance with operations S750 and S760 in FIG. 7 and display the image data on the preset screen. In the embodiment illustrated in FIGS. 10A and 10B, the preset screen is set as a screen of the operator who is positioned remotely and operates the excavator 200.

With reference to FIG. 10B, a device 1060 capable of remotely operating or controlling the excavator 200 may be provided at a location 1050 at which the excavator 200 may be remotely operated or controlled.

The light guide device 400 may display the acquired image data of the periphery of the excavator 200 on a screen 1070 of the device 1060 capable of remotely operating or controlling the excavator 200 (e.g., a screen or the like of the operator of the excavator 200 positioned remotely from the excavator 200). In this case, the image data including a projected object 1070a, which is implemented by the projection module 420 of the light guide device 400 by means of the light with the preset wavelength, may be displayed on the screen 1070 of the device 1060 capable of remotely operating or controlling the excavator 200.

It will be apparent to those skilled in the art to which the present invention belongs that the term “device or module” as used herein refers to a logical unit of organization and not necessarily to physically distinct components.

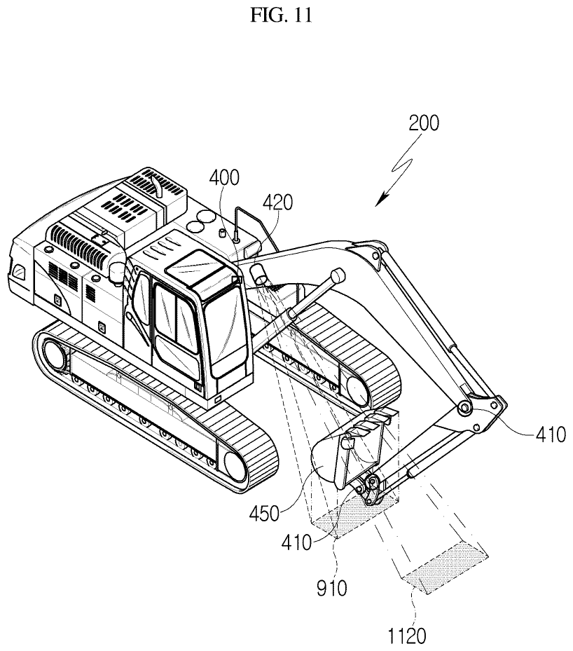

FIG. 11 is a view illustrating a state in which light is projected in a shape corresponding to the shape of the attachment onto the vertically lower side of the attachment included in the excavator and an operation position at which the attachment is to perform the operation.

With reference to FIG. 11, the excavator 200 according to various embodiments may include the light guide device 400, the angle sensor 410, and the projection module 420. In the present embodiment, the excavator 200 may not include the image capturing module 430 and the illuminance sensor 440.

The light guide device 400 may determine the type of the attachment 450 attached to the excavator 200 based on the input of the operator or manager or the like and determine the position and/or attachment angle of the attachment 450 based on the angle of the joint part of the excavator 200 sensed and transmitted by the angle sensor 410 and the type of the attachment 450.

The light guide device 400 may determine the shape of the projected object based on the determined type of the attachment 450 and/or the determined attachment angle of the attachment 450. In the embodiment in FIG. 11, the light guide device 400 may determine the shape of the attachment 450, which is viewed from the vertically lower side, as a shape of a projected object 1110.

In addition, the light guide device 400 may determine the information on the first wavelength and/or the intensity of the light for implementing the projected object at the position on the operation surface corresponding to the attachment 450. Additionally, the light guide device 400 may determine the information on the second wavelength and/or the intensity of the light for implementing the projected object at the operation position at which the attachment 450 is to perform the operation. The first wavelength and the second wavelength may be different from each other.

In addition, the light guide device 400 may determine the operation surface and determine the position on the operation surface onto which the projected object is projected. The light guide device 400 may determine the position, at which the attachment 450 is vertically projected onto the operation surface, as a position onto which the projected object is projected.

The light guide device 400 may determine the operation surface and the operation position at which the attachment 450 needs to operate on the operation surface based on the workplace drawing information, operation information, workplace weather information, and the like.

The light guide device 400 may transmit the control signal, which includes information on the shape of the projected object, the position corresponding to the position of the attachment on the operation surface, the operation position at which the attachment is to operate, and the first wavelength, the second wavelength, and/or the intensity of the light for implementing the projected object, to the projection module 420. The projection module 420 may project a first projected object 1110 onto the position corresponding to the position of the attachment 450 of the vertically lower side of the attachment 450 based on the received control signal, as illustrated in FIG. 11, and the projection module 420 may project a second projected object 1120 onto the operation position at which the attachment 450 is to operate. In this case, the example has been described in which the first projected object 1110 and the second projected object 1120 may have the same shape. However, the first projected object 1110 and the second projected object 1120 may have different shapes. In addition, the first projected object 1110 and the second projected object 1120 may have different sizes even though the first projected object 1110 and the second projected object 1120 have the same shape.

It will be apparent to those skilled in the art to which the present invention belongs that the term “device or module” as used herein refers to a logical unit of organization and not necessarily to physically distinct components.

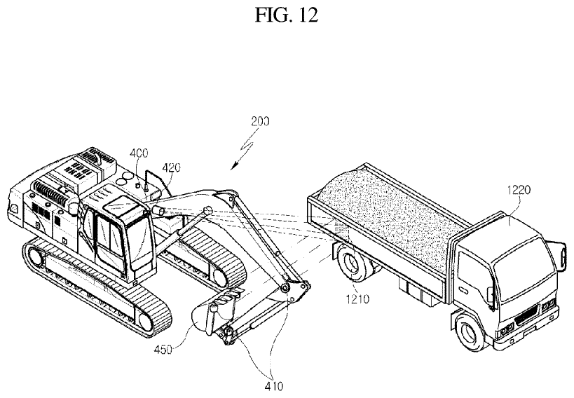

FIG. 12 is a view illustrating a state in which light is projected in a shape corresponding to a shape of an attachment onto an operation surface on which the attachment attached to the excavator is to perform an operation according to another embodiment.

In the embodiment in FIG. 12, an example is described in which a shape of a bucket, which is the attachment 450 attached to the excavator 200 and corresponding in shape to the attachment, is projected onto a lateral surface of a dump truck, which may be an operation surface, during a process in which the bucket scoops up the soil and loads the soil into the dump truck.

With reference to FIG. 12, the excavator 200 according to various embodiments may include the light guide device 400, the angle sensor 410, and the projection module 420. In the present embodiment, the excavator 200 may not include the image capturing module 430 and the illuminance sensor 440.

The light guide device 400 may determine the type of the attachment 450 attached to the excavator 200 based on the input of the operator or manager or the like and determine the position and/or attachment angle of the attachment 450 based on the angle of the joint part of the excavator 200 sensed and transmitted by the angle sensor 410 and the type of the attachment 450.

The light guide device 400 may determine the shape of the projected object based on the determined type of the attachment 450 and/or the determined attachment angle of the attachment 450. In the embodiment in FIG. 12, the operation surface may be a flat surface including the lateral surface of a dump truck 1220, and the light guide device 400 may determine a shape, when the attachment 400 is projected onto the operation surface that is the flat surface including the lateral surface of the dump truck 1220, as the shape of the projected object.

In addition, the light guide device 400 may determine the information on the wavelength and/or the intensity of the light for implementing a projected object 1210 at the position on the operation surface corresponding to the position of the attachment 450.

In addition, the light guide device 400 may determine the operation surface and determine the position on the operation surface onto which the projected object is projected. The light guide device 400 may determine the position, at which the attachment 450 is vertically projected onto the operation surface, as a position onto which the projected object is projected.

The light guide device 400 may determine the operation surface and the operation position at which the attachment 450 needs to operate on the operation surface based on the workplace drawing information, operation information, workplace weather information, and the like.

The light guide device 400 may transmit the control signal, which includes information on the shape of the projected object, the position at which the projected object is to be projected, and the wavelength and/or intensity of the light for implementing the projected object, to the projection module 420, and the projection module 420 may project the projected object 1210 onto the position corresponding to the position of the attachment 450 on the operation surface based on the received control signal, as illustrated in FIG. 12.

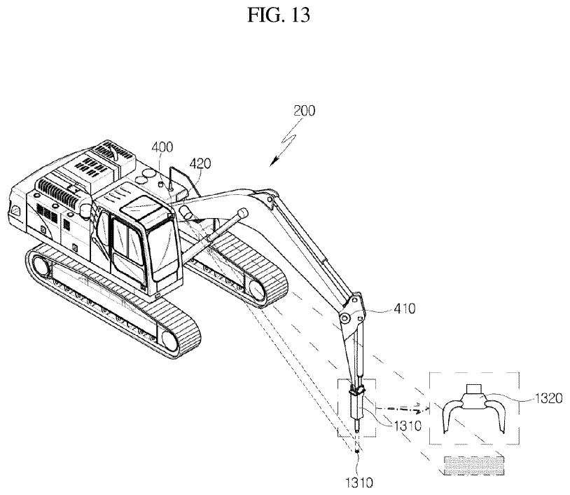

FIG. 13 is a view illustrating a state in which a shape corresponding to a shape of an attachment is transformed and projected depending on the attachment attached to the excavator according to the embodiment.

At operation S620, the light guide device 400 may determine the types of attachments 1310 and 1320 attached to the front working device 230 of the excavator 200 based on the input of the operator or manager and the like. Then, the light guide device 400 may change the shape of the projected object based on the determined types of the attachments 1310 and 1320.

With reference to FIGS. 9 to 12, in case that the attachment 450 is the bucket, the shape of the projected object is similar to square. In contrast, with reference to FIG. 13, in case that the attachment 450 is a hammer, the shape of the projected object may be a circular shape suitable for a thickness of the hammer. In case that the attachments 450 are pincers, the shape of the projected object may be a rectangular suitable for a degree to which the pincers are spread.

The shape of the projected object may be variously set in accordance with the type and/or size of the attachment 450 and stored in the memory 530 or the database. In addition, the shape of the projected object may be a shape made by vertically projecting the attachment 450 onto the operation surface. In this case, the shape of the projected object may be calculated and derived in real time.

According to the embodiment of the present invention, the position of the distal end of the working machine included in the excavator may be projected onto the terrain on which the excavator is positioned.

In addition, the operation position at which the distal end of the working machine included in the excavator is to operate may be projected onto the terrain on which the excavator is positioned.

In addition, the image data of the periphery of the excavator, which indicate the position of the attachment included in the excavator and/or the operation position at which the attachment attached to the excavator is to perform the operation, on the screen of the excavator operator positioned remotely from the excavator.

All the constituent elements, which constitute the embodiment of the present invention, may be integrally coupled or operate by being combined, but the present invention is not necessarily limited to the embodiment. That is, one or more of the constituent elements may be selectively combined and operated within the object of the present invention.

In addition, all the constituent elements may be implemented as a single independent hardware device, but some or all of the constituent elements may be selectively combined and implemented as a computer program having a program module that performs some or all of the functions combined by one or more hardware devices. Codes and code segments, which constitute the computer program, may be readily inferred by those skilled in the art of the present invention.

The computer program may be stored on computer-readable storage media and read and executed by a computer, thereby implementing the embodiment of the present invention. The storage media of the computer program may include a magnetic recording medium, an optical recording medium, or the like.

In addition, unless explicitly described to the contrary, the words “comprise,” “include,” or “have” and variations such as “comprises,” “comprising,” “includes,” “including,” has,” or “having,” should be understood to imply the inclusion of stated elements but not the exclusion of any other elements.

Unless otherwise defined, all terms including technical or scientific terms may have the same meaning as commonly understood by those skilled in the art to which the present invention pertains. The terms such as those defined in a commonly used dictionary may be interpreted as having meanings consistent with meanings in the context of related technologies and may not be interpreted as ideal or excessively formal meanings unless explicitly defined in the present invention.

The above description is simply given to illustratively describe the technical spirit of the present invention, and those skilled in the art to which the present invention pertains will appreciate that various changes and modifications are possible without departing from the essential characteristic of the present invention.

Therefore, the embodiments disclosed in the present invention are provided for illustrative purposes only but are not intended to limit the technical spirit of the present invention. The scope of the technical spirit of the present invention is not limited thereby. The protective scope of the present invention should be construed based on the following claims, and all the technical spirit in the equivalent scope thereto should be construed as falling within the scope of the present invention.

What is claimed is:

1. A light guide system comprising:
an angle sensor disposed for each of joint parts of an excavator and configured to acquire an angle of each of the joint parts of the excavator;
a projection module configured to implement a projected object by using light; and
a light guide device operatively connected to the angle sensor and the projection module,
wherein the light guide device is configured to:
determine a position of an attachment attached to the excavator based on the angle of each of the joint parts of the excavator acquired by the angle sensor;
determine an operation surface based on workplace drawing information or operation information; and
generate a control signal for projecting the projected object onto a projection position on the operation surface corresponding to a position of the attachment and transmit the control signal to the projection module, and
wherein the projection module implements the projected object onto the projection position on the operation surface based on the received control signal.

2. The light guide system of claim 1, wherein the light guide device is further configured to:
determine the type of the attachment attached to the excavator; and
determine a shape of the projected object based on the determined type of the attachment.

3. The light guide system of claim 2, wherein the light guide device is further configured to determine the projection position as a position at which the attachment is vertically projected onto the operation surface, and
wherein the shape of the projected object is a shape when the attachment is vertically projected onto the operation surface.

4. The light guide system of claim 3, wherein the light guide device is configured to:
include information on the projection position and the shape of the projected object in the control signal; and
transmit the control signal to the projection module, and
wherein the projection module is configured to implement the projected object at the projection position by using light with a first wavelength preset therein.

5. The light guide system of claim 3, wherein the light guide device is configured to:
determine a second wavelength of light for implementing the projected object;
include information on the second wavelength, the projection position, and the shape of the projected object in the control signal; and
transmit the control signal to the projection module, and
wherein the projection module is configured to implement the projected object at the projection position by using the light with the second wavelength.

6. The light guide system of claim 3, wherein the light guide device is configured to:
determine an operation position at which the attachment is to operate based on the workplace drawing information or the operation information;
include information on the operation position, the projection position, and the shape of the projected object in the control signal; and
transmit the control signal to the projection module, and
wherein the projection module is configured to:
implement the projected object at the projection position by using light with a preset first wavelength; and
implement the projected object at the operation position by using light with a preset third wavelength.

7. The light guide system of claim 1, further comprising:
an image capturing module configured to acquire image data of a periphery of the excavator,
wherein the light guide device is further configured to display image data acquired by the image capturing module on a preset screen.

8. The light guide system of claim 7, wherein the preset screen includes at least one of a screen provided in an operator seat of the excavator and a screen provided to an operator who remotely operates the excavator.

9. A method of providing a light guide to an excavator by a light guide system, the method comprising:
determining the type of attachment attached to the excavator;
acquiring an angle of each of joint parts of the excavator;
determining a position of the attachment attached to the excavator based on the angle of each of the joint parts of the excavator;
determining a shape of a projected object based on the determined type of the attachment; and
implementing the projected object at a projection position on an operation surface corresponding to the position of the attachment.

10. The method of claim 9, wherein the implementing of the projected object at the projection position on the operation surface comprises determining the operation surface based on workplace drawing information or operation information.

11. The method of claim 10, wherein the implementing of the projected object at the projection position on the operation surface comprises determining the projection position as a position at which the attachment is vertically projected onto the operation surface, and
wherein the determining of the shape of the projected object comprises determining the shape of the projected object as a shape when the attachment is vertically projected onto the operation surface.

12. The method of claim 11, wherein the implementing of the projected object at the projection position on the operation surface comprises:
transmitting, by a light guide device, a control signal including information on the projection position and the shape of the projected object to a projection module; and
implementing, by the projection module, the projected object at the projection position by using light with a first wavelength preset therein.

13. The method of claim 11, wherein the implementing of the projected object at the projection position on the operation surface comprises:
determining a second wavelength of light for implementing the projected object;
transmitting, by a light guide device, a control signal including information on the second wavelength, the projection position, and the shape of the projected object to a projection module; and
implementing, by the projection module, the projected object at the projection position by using the light with the second wavelength.

14. The method of claim 11, further comprising:
determining an operation position at which the attachment is to operate based on the workplace drawing information or the operation information,
wherein the implementing of the projected object at the projection position on the operation surface comprises:
transmitting, by a light guide device, a control signal including information on the operation position, the projection position, and the shape of the projected object to a projection module; and
implementing, by the projection module, the projected object at the projection position by using light with a preset first wavelength and implementing the projected object at the operation position by using light with a preset third wavelength.

15. The method of claim 9, further comprising:
acquiring image data of a periphery of the excavator; and
displaying the acquired image data on a preset screen.

16. The method of claim 15, wherein the preset screen includes at least one of a screen provided in an operator seat of the excavator and a screen provided to an operator who remotely operates the excavator.

17. An excavator comprising:
an angle sensor disposed for each of joint parts of the excavator and configured to acquire an angle of each of the joint parts of the excavator;
a projection module configured to implement a projected object by using light; and
a processor operatively connected to the angle sensor and the projection module,
wherein the processor is configured to:
determine a position of an attachment attached to the excavator based on the angle of each of the joint parts of the excavator acquired by the angle sensor;
determine an operation surface based on workplace drawing information or operation information; and
generate a control signal for projecting the projected object onto a projection position on the operation surface corresponding to a position of the attachment and transmit the control signal to the projection module, and
wherein the projection module implements the projected object onto the projection position on the operation surface based on the received control signal.

18. The excavator of claim 17, wherein the processor is further configured to:
determine the type of the attachment attached to the excavator;
determine the projection position as a position at which the attachment is vertically projected onto the operation surface, and
determine the shape of the projected object being a shape when the attachment is vertically projected onto the operation surface.

19. The excavator of claim 17, wherein the processor is configured to:
include information on the projection position and the shape of the projected object in the control signal and
transmit the control signal to the projection module, and
wherein the projection module is configured to implement the projected object at the projection position by using light with a first wavelength preset therein.

20. The excavator of claim 20, wherein the processor is further configured to:
determine a second wavelength of light for implementing the projected object;
include information on the second wavelength, the projection position, and the shape of the projected object in the control signal; and
transmit the control signal to the projection module, and
wherein the projection module is configured to implement the projected object at the projection position by using the light with the second wavelength.
